(19) United States
(12) Patent Application Publication
(10) Pub. No.: US 2009/0009674 A1
(43) Pub. Date: Jan. 8, 2009

(54) LIQUID CRYSTAL DISPLAY PANEL AND THE MANUFACTURING METHOD OF THE SAME

(75) Inventors: Techen CHUNG, KunShan City (CN); Teansen JEN, KunShan City (CN)

Correspondence Address: CALFEE HALTER & GRISWOLD, LLP, 800 SUPERIOR AVENUE, SUITE 1400, CLEVELAND, OH, 44114, US

(73) Assignee: INFOVISION OPTOELECTRONICS (KUNSHAN) CO., LTD., KunShan City (CN)

(21) Appl. No.: 12/141,554

(22) Filed: Jun. 18, 2008

(30) Foreign Application Priority Data
Jul. 6, 2007 (CN) 200710136572.2

(51) Int. Cl. G02F 1/133; G02F 1/13

(52) U.S. Cl. 349/39; 438/30; 257/E21.535

(57) ABSTRACT

The invention discloses a liquid crystal display panel comprising a plurality of scan lines, a plurality of data lines, a plurality of pixels and pixel storage capacitors. Each pixel storage capacitor comprises a first storage capacitor and a second storage capacitor, the capacitance value thereof is decreased as the distance between the corresponding pixel and the input terminal of the scan signal increases. The invention also discloses a manufacturing method for liquid crystal display panel, comprising: forming the scan lines and the first capacitor electrodes, depositing an insulating layer on the scan lines and the first capacitor electrodes to form the first insulating layer; depositing a patterned semiconductor layer on said insulating layer to form the electron induced layer; forming the data lines and the second capacitor electrodes; and depositing sequentially the second insulating layer and a transparent conductive layer on the data lines and the second capacitor electrodes, wherein the pixel storage capacitor in the pixel close to the input terminal of the scan signal is arranged to have a larger capacitance value than the pixel storage capacitor in the pixel far from the input terminal of the scan signal. By using the liquid crystal display panel and the manufacturing method of the same of the invention, the feed-through voltage of the respective pixels can be kept unchangeable substantially, and therefore, the flicker phenomenon of the image of TFT-LCD can be reduced effectively.

### FIELD OF THE INVENTION

The invention relates to a liquid crystal display panel, particularly, relates to a liquid crystal display panel having a capability to effectively reduce the flicker of the image

### BACKGROUND OF THE INVENTION

Recently, as the arriving of the information society, the requirement for the personal computer (PC), car navigation system, personal digital assistant, information communication device, and the combination of the above products has been increased rapidly. The above products need high visibility, wide visual angle and high response speed for displaying moving images. Flat panel display (FPD) has the above characteristics, so that the people have paid attention to FPD and it may be developed as the next generation of the display.

Furthermore, the thin film transistors (TFTs) have been used widely in the display devices, such as the organic light emitting display (OLED) or flat panel display or the like, as the switch elements for controlling each of the pixels. Therefore, people have suggested that FPD having TFTs with higher efficiency and the method for driving such FPD be used. Specifically, the thin film transistor flat panel display, particularly, the thin film transistor liquid crystal display (Hereinafter referred to as TFT-LCD) has gradually replaced the traditional CRT (Cathode ray tube) monitor due to TFT-LCD is thinner and lighter, and has lower power consumption and no radiation pollution, and the like.

In the prior art, TFT-LCD comprises a plurality of scan lines and scan driver circuits thereof, a plurality of data lines and data driver circuits thereof, a plurality of common electrode lines and a plurality of pixel units, and the like. Each of the plurality of pixel units is formed at the intersection of one of a plurality of scan lines and a corresponding one of a plurality of data lines an the glass substrate, wherein the scan lines are perpendicular to the data lines. Furthermore, a thin film transistor is disposed at the intersection of the scan line and the data line to drive the pixel unit and produce images with various patterns and colors. When the voltage is applied to the liquid crystal in the respective pixels, a certain relationship exists between the voltage and the penetration capability of the light, that is, it is only required to control the voltage value applied to the liquid crystal to allow the respective pixels having a light transmission rate corresponding to said voltage value. More specifically, when a voltage drop is produced in the potential of the pixel electrode Vₚ, the potential of the pixel electrode Vₚ is different on the positive and negative voltage vibration of the pixel electrode: under a polarity in which the voltage vibration is larger, the light transmission rate is lower, and under a polarity in which the voltage vibration is smaller, the light transmission rate is higher. Thereby different brightness is produced repeatedly according to the light transmission rate changing higher or lower, this phenomenon is called “flicker”.

The potential variation of the pixel electrode ΔVₚ depends on the delay time of the gate signal falling. When the TFT is to be a switch-off state and the gate voltage is cut off, the voltage is not cut off by a rectangular shape having a sharp angle, but a circular angle form, and a delay time (t) is produced before the voltage changes to zero. When the delay time of the falling edge of the gate signal is large, TFT cannot be turned of completely, so the charges leak from the pixel electrode via TFT, producing the potential variation of the pixel electrode. The potential variation of the pixel electrode is called feed-through voltage (Hereinafter indicated by V_{FD}). In this way, the effect caused by the feed-through voltage in the respective pixels is different, so the flicker of the images of TFT-LCD may appear.

### SUMMARY OF THE INVENTION

Aiming at overcoming the above technical defects existing in the use of the liquid crystal display panel in the prior art, the present invention provides a liquid crystal display panel and a manufacturing method of the same, which can effectively reduce the flickers of the image.

According to one aspect of the invention, it provides a liquid crystal display panel, which comprises a plurality of scan lines, a plurality of data lines, a plurality of pixels formed by intersecting perpendicularly the scan lines with the corresponding data lines, and a plurality of pixel storage capacitors disposed in the pixels. Wherein, each pixel storage capacitor comprises a first storage capacitor and a second storage capacitor, which are connected in parallel with each other, and the capacitance value of each pixel storage capacitor is decreased as the distance between the corresponding pixel and the input terminal of the scan signal increases.

According to another aspect of the invention, it provides a method for manufacturing liquid crystal display panel. Said manufacturing method can be realized by the steps of:

the scan lines and the first capacitor electrodes are formed by forming a patterned metal layer on a glass substrate;

an insulating layer is deposited on the scan lines and the first capacitor electrodes to form a first insulating layer;

next, a patterned semiconductor layer is deposited on said insulating layer to form the semiconductor layer and the electron induced layer of the thin film transistor;

next, another patterned metal layer is deposited to form the data lines and the second capacitor electrodes; and

the second insulating layer and a transparent conductive layer is deposited sequentially on the data lines and the second capacitor electrodes, said transparent conductive layer forms the pixel electrodes and the third capacitor electrodes, wherein the pixel storage capacitor in the pixel closer to the input terminal of the scan signal is disposed to have a larger capacitance than the pixel storage capacitor in the pixel further from the input terminal of the scan signal;

By using the liquid crystal display panel and the manufacturing method of the same in the present invention, the feed-through voltage of the respective pixels can be substantially constant, and therefore, the flicker phenomenon of the image of TFT-LCD can be reduced effectively.

### BRIEF DESCRIPTION OF THE DRAWINGS

After reading the specific embodiments of the present invention in connection with the drawings by the readers, the respective aspects of the invention can be understood more clearly. Wherein:

FIG. 1 illustrates a schematic view of a panel of TFT-LCD in the prior art;

FIG. 2 illustrates a schematic view of an equivalent circuit of a pixel in TFT-LCD;

FIG. 3 illustrates a schematic view of a graph showing the change of the feed-through voltage V_{FD} in the pixels as the length between a pixel and the input terminal of a scan line changes according to the prior art;

FIG. 4 illustrates a top view of a pixel array substrate of TFT-LCD according to the first embodiment of the invention;

FIG. 5 illustrates a cross sectional schematic view of a pixel storage capacitor as shown in FIG. 4 and taken along line I-I;

FIG. 6 illustrates a change relationship graph of the second storage capacitor and the applied voltage thereon;

FIG. 7 illustrates a top view of a pixel array substrate of TFT-LCD according to the second embodiment of the invention;

FIG. 8 illustrates a top view of a pixel array substrate of TFT-LCD according to the third embodiment of the invention;

FIG. 9 illustrates a schematic view of a graph showing the change of the capacitance value of the pixel storage capacitor of a pixel as the distance between the pixel and the input terminal of a scan line according to the above embodiments of the invention changes; and

FIG. 10 illustrates a schematic view of a graph showing the change of the feed-through voltage V_{FD} as the length between a pixel and the input terminal of a scan line changes according to the above embodiments of the invention changes.

### DESCRIPTION OF THE PREFERRED EMBODIMENTS

The specific embodiments of the invention will be further described in detail by referring to the drawings as follows.

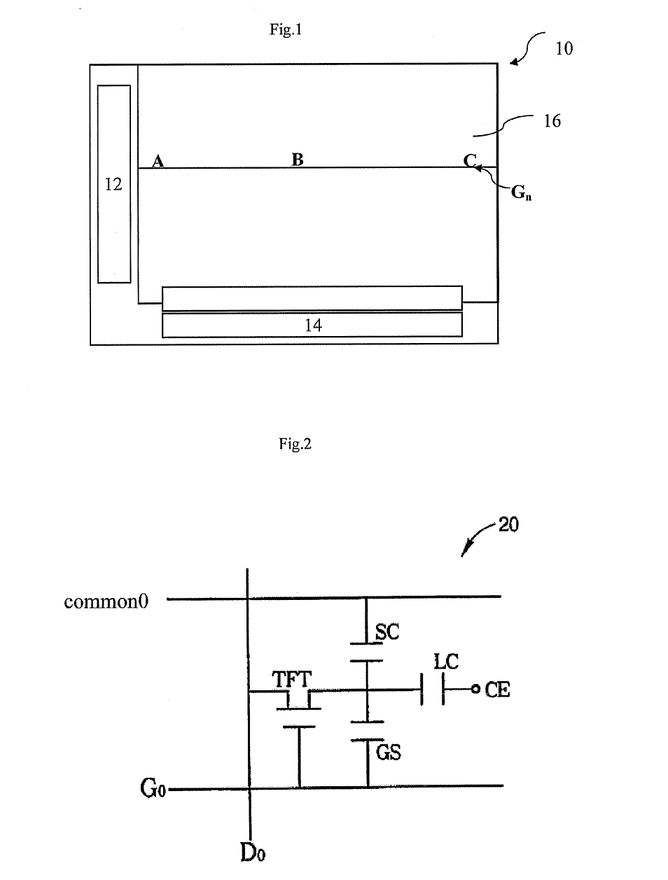

FIG. 1 illustrates a schematic view of a panel of TFT-LCD in the prior art. Referring to FIG. 1, TFT-LCD panel 10 comprises a plurality of scan lines 12, a plurality of data lines 14 and a pixel array region 16. Wherein a plurality of pixels are included in the pixel array region 16, and pixel A, pixel B and pixel C in FIG. 1 are three different pixels located on the same scan line Gₙ, and are arranged sequentially according to the increase of the distance from the input terminal of the scan line Gₙ, that is, pixel A is close to the input terminal of the scan line Gₙ, while pixel C is far from the input terminal of the scan line Gₙ.

FIG. 2 illustrates a schematic view of an equivalent circuit of a pixel in TFT-LCD. Referring to FIG. 2, pixel 20 comprises a liquid crystal capacitor LC and a pixel storage capacitor SC. One terminal of the liquid crystal capacitor is connected with the common electrode CE, and the other terminal is connected with the source electrode of the thin film transistor TFT. The thin film transistor TFT comprises a source electrode, a gate electrode and a drain electrode, the drain electrode is connected with the data line D₀, the gate electrode is connected with the scan line G₀, and the source electrode is connected with the pixel storage capacitor, and a capacitor, GS, is also formed between the source electrode and the gate electrode of the thin film transistor TFT. One terminal of the pixel storage capacitor SC is connected with the liquid crystal capacitor and the source electrode of the thin film transistor and the other terminal is connected with the common electrode line common0. The charge storage function of the pixel storage capacitor SC is utilized to reduce the effect of the leakage current on the voltage of the liquid crystal capacitor.

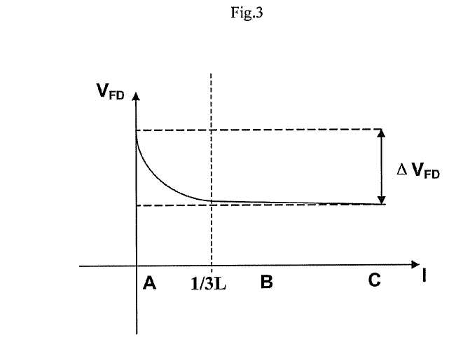

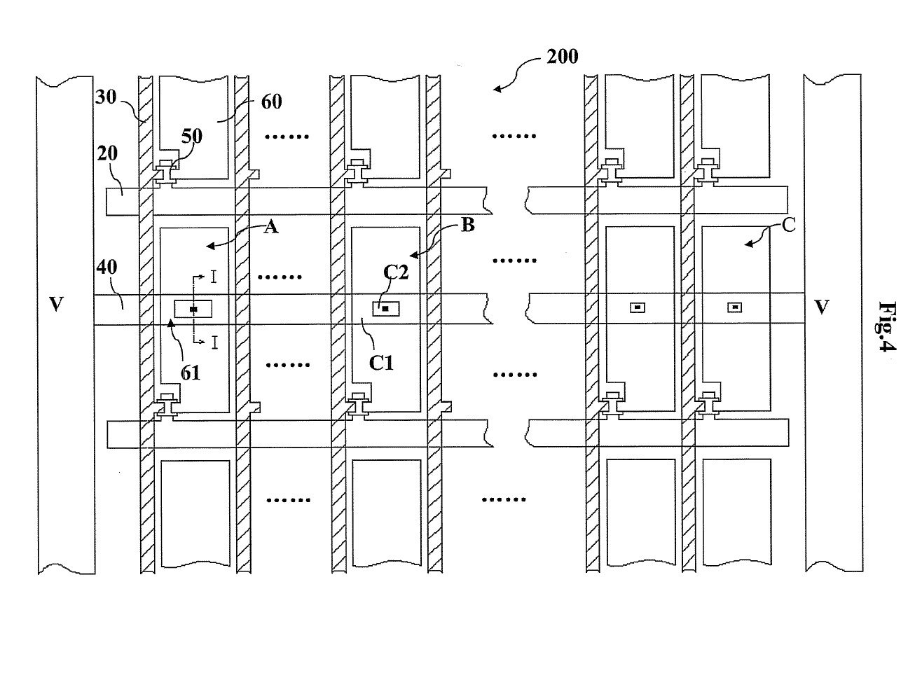

FIG. 3 illustrates a schematic view of a graph showing the change of the feed-through voltage Y_{FD} in each pixel as the length l between each pixel and the input terminal of a scan line changes. It is supposed that the capacitance value of the liquid crystal capacitor LC is C_{LC}, the capacitance value of the pixel storage capacitor SC is C_{SC}, the capacitance value of the capacitor GS, between the gate electrode and the source electrode of the thin film transistor TFT is C_{GS}, the difference value of the voltages applied to the scan line as the turn on voltage and turn off voltage of the scan signal is ΔV_{G}, then the feed-through voltage of the pixel V_{FD} can be expressed as formula (1):

$${V}_{FD} = \frac{{C}_{GS}}{{C}_{LC} + {C}_{SC} + {C}_{GS}} \times Δ {V}_{G}$$

Wherein the value of ΔV_{G} is a constant value, while the capacitance value of the pixel storage capacitor C_{SC} and (he capacitance value of the liquid crystal capacitor C_{LC} are larger significantly than the capacitance value of the capacitor between the gate electrode and the source electrode of the thin film transistor TFT C_{GS}, that is, C_{SC}>>C_{GS}, and C_{LC}>>C_{GS}. The above formula can also be rewritten as formula (2);

$${V}_{VD} = \frac{{C}_{GS}}{{C}_{LC} + {C}_{SC}} \times Δ {V}_{G}$$

When C_{SC} of pixel A, pixel B and pixel C on the same scan line are equal, and C_{GS} and C_{LC} are the same with C_{SC}, the feed-through voltages of pixel A, pixel B and pixel C are decreased as the distance from the pixel to the input terminal of the scan line being increased because of the resistance and capacitor effect in the scan line, that is, (V_{FD})_{A}>(V_{FD})_{B}>(V_{FD})_{C}.

FIG. 4 illustrates a top view of a pixel array substrate of TFT-LCD according to the first embodiment of the invention. The pixel array substrate 200 is mainly composed of a plurality of scan lines 20, a plurality of data lines 30 and a plurality of common electrode lines 40, wherein the scan lines 20 and the data lines 30 are disposed on a glass substrate 2 and intersected perpendicularly with each other to form a plurality of pixels, such as pixel A, pixel B and pixel C. Meanwhile, a thin film transistor TFT 50 is disposed at the intersection of the scan line 20 and the data line 30, a common electrode line 40 is in parallel with the scan line 20 and is located at the center portion of the pixel, the pixel electrode 60 is connected with the data line 30 via the thin film transistor 50.

It is known from the above formula (2), when C_{SC} of pixel A, pixel B and pixel C on the same scan line are equal, and C_{GS} and C_{LC} are the same with C_{SC}, then, (V_{FD})_{A}>(V_{FD})_{B}>(V_{FD})_{C}. However, if the capacitance value of the pixel storage capacitor of pixel A, pixel B and pixel C satisfies (C_{SC})_{A}>(C_{SC})_{B}>(C_{SC})_{C}, and satisfies simultaneously (C_{GS})_{A}=(C_{GS})_{B}=(C_{CS})_{C} and (C_{LC})_{A}=(C_{LC})_{B}=(C_{LC})_{C}, then it will be completely possible to adjust the feed-through voltage of three pixels V_{FD}, pixel A, pixel B and pixel C, to be equal or approximately equal FIG. 5 illustrates a cross sectional schematic view of a pixel storage capacitor 61 as shown in FIG. 4 and taken along line I-I. As shown in FIG. 5, the pixel storage capacitor 61 is formed on the glass substrate 2, and the capacitance value of the pixel storage capacitor 61 C_{SC} is the sum of the capacitance value of the first storage capacitor C1 and the capacitance value of the second storage capacitor C2. Wherein the first storage capacitor is formed by the first capacitor electrode 100, the dielectric formed by the first insulating layer 101 and the second insulating layer 104, and the third capacitor electrode 105, and the second storage capacitor is formed by the first capacitor electrode 100, the dielectric formed by the first insulating layer 101, and the second capacitor electrode 103, and a electron induced layer 102 is also disposed between the first capacitor electrode 100 and the second capacitor electrode 103. Wherein the size of the electron induced layer 102 and the size of the second capacitor electrode are the same. Through hole 106 is disposed on the second insulating layer 104 above the second capacitor electrode 103 to allow the third capacitor electrode 105 to be connected electrically with the second capacitor electrode 103 via the through hole 106. It will be understood by those skilled in the art, the electron induced layer 102 in the embodiment is disposed between the first capacitor electrode 100 and the second capacitor electrode 103, more specifically, the electron induced layer 102 is disposed between the fast insulating layer 101 and the second capacitor electrode, but it is not restricted to this. For example, the electron induced layer 102 can be disposed between the first capacitor electrode 100 and the first insulating layer 101 with different manufacturing processes.

Referring to FIG. 4 and FIG. 5, the pixel array substrate 200 can be formed by the steps sequentially as follows: firstly, a patterned metal layer is formed on the glass substrate 2 to form the scan lines 20 and the first capacitor electrode 102; an insulating layer is deposited on the scan lines 20 and the first capacitor electrode, 100 to form the first insulating layer 101; texts a patterned semiconductor layer is deposited on said insulating layer to form the semiconductor layer (not shown) of the thin film transistor 50 and the electron induced layer 102; next, another patterned metal layer is deposited to form the data lines 30 and the second capacitor electrode 103; then another insulating layer and a transparent conductor layer is deposited sequentially on the data lines 30 and the second capacitor electrode 103, the transparent conductor layer forms the pixel electrode 60 and the third capacitor electrode 105. In the embodiment, the first capacitor electrode 100 and the second capacitor electrode 103 are made of metal material, such as Al. While the third capacitor electrode and the pixel electrode are made of transparent conductor medium, such as ITO, and the like.

An opposing area S [symbol] between the second capacitor electrode 103 and the first capacitor electrode 100 of each pixel on the same scan line, such as pixel A, pixel B and pixel C, is decreased to different extent as the distance between the corresponding pixel and the input terminal of the scan signal being increased, so as to the capacitance value of the second storage capacitor C2 of each pixel is reduced as the distance between the corresponding pixel and the input terminal of the scan signal being increased, for example (C²)_{A}>(C²)_{B}>(C²)_{C}, meanwhile, the capacitance value of the first storage capacitor C1 of each pixel, such as pixel A, pixel B and pixel C, is increased as the distance between the corresponding pixel and the input terminal of the scan signal being increased due to the increase of the opposing area between the first capacitor electrode 100 and the third capacitor electrode 105 of the corresponding pixel, however, the increased amount of the capacitance value of the first storage capacitor C1 of a pixel is smaller than the decreased amount of the capacitance value of the second storage capacitor C2 of the pixel, that is, the decreased amount of the capacitance value of the second storage capacitor C2 of the pixel is larger than the increased amount of the capacitance value of the first storage capacitor C1 of the pixel, thereby it causes the capacitance value of the pixel storage capacitor C_{SC} of the pixel, which is the sum of the capacitance value of the first storage capacitor C1 of the pixel and the capacitance value of the second storage capacitor C2 of the pixel, to be decreased correspondingly as the distance between the corresponding pixel and the input terminal of the scan signal being increased Therefore, by decreasing the opposing area S between the second capacitor electrode 103 and the first capacitor electrode 100 of a pixel as the distance between the corresponding pixel and the input terminal of the scan signal being increased, the capacitance value of the pixel storage capacitor C_{SC} of the pixel is deceased correspondingly as the distance between the corresponding pixel and the input terminal of the scan signal being increased, in this way, the capacitance value of the pixel storage capacitor C_{SC} of pixel A, pixel B and pixel C on the same scan line satisfies the inequality (C_{SC})_{A}>(C_{SC})_{B}>(C_{SC})_{C}. Thereby the feed-through voltage of pixel A, pixel B and pixel C are adjusted to be substantially equal.

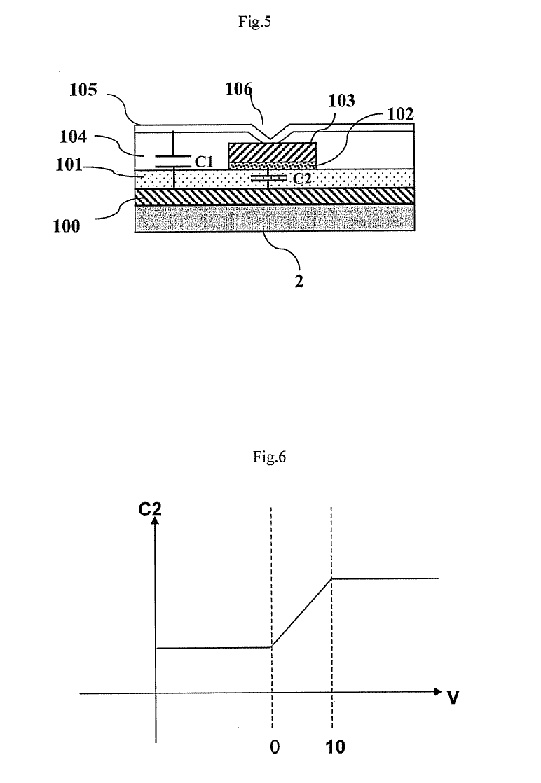

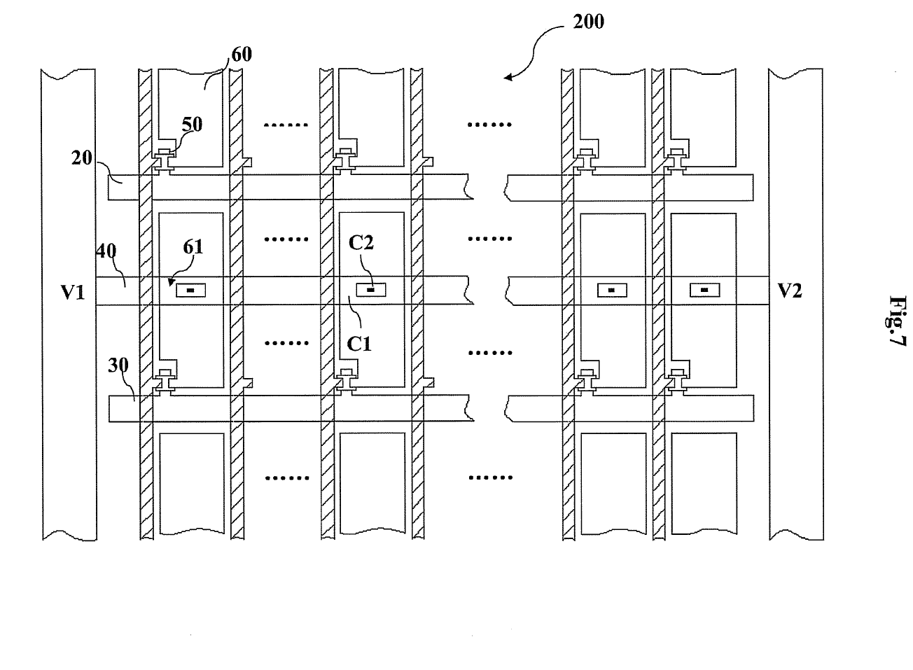

FIG. 6 illustrates a change relationship graph of the second storage capacitor of each pixel and the applied voltage thereon. An electron induced layer 102 formed by amorphous silicon is disposed between two capacitor electrodes, that is, the first capacitor electrode 100 and the second capacitor electrode 103, of the second storage capacitor of each pixel. It is known from the characteristics of the semiconductor, when a positive voltage is applied to the first capacitor electrode 100, the induced electrons will be produced on the surface where the electron induced layer 102 contacts with the first insulating layer 101, these induced electrons affect the capacitance value of the second storage capacitor C2 of each pixel. When the voltage value of the positive voltage is increased, the amount of the induced electrons produced is also increased; when the voltage value of the positive voltage is decreased, the amount of the induced electrons produced is also decreased. When different voltages are applied on the first capacitor electrode 100 of a second storage capacitor, the amount of the induced electrons produced on the surface where the electron induced layer 102 contacts with the first insulating layer 101 is different, and the capacitance value of the second storage capacitor C2 is also different. In other words, the capacitance value of the second storage capacitor C2 is changed as the voltage applied to the first capacitor electrode 100 changes. When the difference of the voltage applied between the first capacitor electrode 100 and the second capacitor electrode 103 is 0V to 10V, the capacitance value of the second storage capacitor C2 is increased as the difference of voltage applied between the first capacitor electrode 100 and the second capacitor electrode 103 being increased. FIG. 7 illustrates a top view of a pixel array substrate of TFT-LCD according to the second embodiment of the invention. Referring to FIG. 7, when the voltage on the second capacitor electrode 103 of each pixel keeps constant, different voltages V1 and V2 are applied respectively to the input terminal and a terminal far from the input terminal of the common electrode line, that is, the first capacitor electrode 100 of each pixel, and it satisfies V1>V2.

Referring to FIG. 6 and FIG. 7, the value of difference of the voltage applied to the first capacitor electrode 100 and the second capacitor electrode 103 of each pixel is set based on the medium material of the second storage capacitor of each pixel, the material characteristic of the electron induced layer 102, the thickness of the respective materials, and the position of the electron induced layer 102, and the like, thus, the capacitance values of the pixel storage capacitor of pixel A, pixel B and pixel C can satisfy the following inequality: (C_{SC})_{A}>(C_{SC})_{B}>(C_{SC})_{C}. In the embodiment, the medium material of the second storage capacitor of each pixel is formed by the first insulating layer 101, which is formed by silicon nitride, while the electron induced layer 102 is formed of amorphous silicon material. Different material can be selected based on different manufacturing processes, and the materials used in the embodiment cannot be understood as the restriction to the materials of the respective layer. For example, polycrystalline semiconductor material, or monocrystalline semiconductor material can be used to form the electron induced layer 102. For example, in the embodiment; the electron induced layer 102 is disposed above the first insulating layer 101 and is located below the second capacitor electrode 103, however, the electron induced layer 102 can be disposed above the first capacitor electrode 100 and be located below the first insulating layer 101 based on different manufacturing processes, these arrangement methods of the electron induced layer can adjust the capacitance value of the pixel storage capacitor C_{SC} to realize the adjustment of the feed-through voltage of the respective pixels V_{FD}. In the second embodiment the opposing areas S of the second capacitor electrode 103 and the first capacitor electrode 100 of each pixel, such as pixel A, pixel B and pixel C, is equivalent.

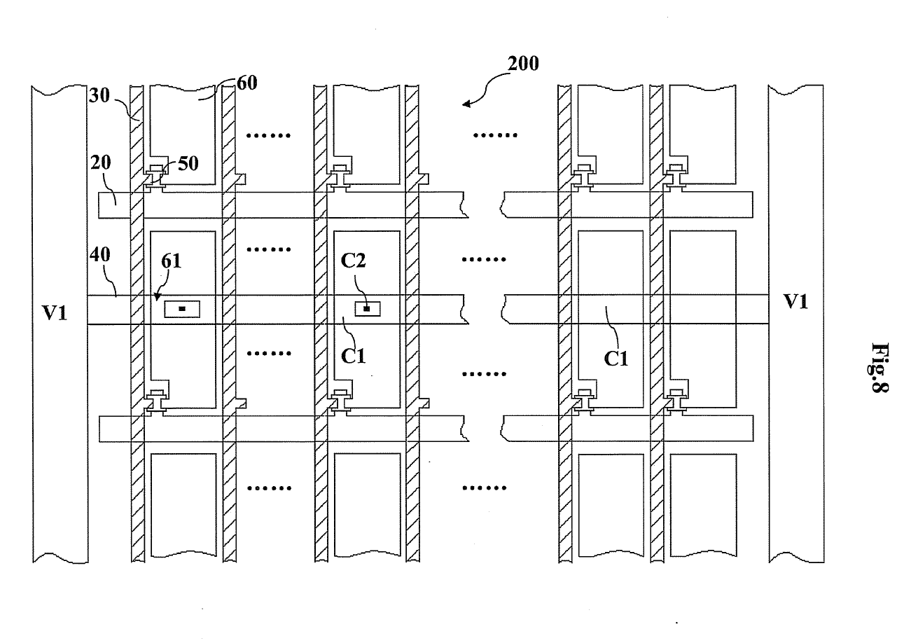

FIG. 3 illustrates a schematic view of a graph showing the change of the feed-through voltage V_{FD} as the length I from a pixel to the input terminal of a scan line changes. It can be seen from FIG. 3, from a place having a distance of ⅓ of the length of the liquid crystal display panel L departing from the input terminal of the scan signal to another terminal far from the input terminal of the scan signal, the falling of the feed-through voltage of the respective pixels V_{FD} is smooth or constant substantially. Therefore, from a corresponding position departing from the input terminal of the scan signal to another terminal far from the input terminal of the scan signal, the capacitance value of the pixel storage capacitor C_{SC} of the respective pixels can be substantially equivalent FIG. 8 illustrates a top view of a pixel army substrate of TFT-LCD according to the third embodiment of the invention. Referring to FIG. 3 and FIG. 8, when the same voltage V1 is applied to the input terminal of the common electrode line, that is, the first capacitor electrode 100 of each pixel, and another terminal far from the input terminal, from an appropriate position departing from the input terminal of the scan signal to another terminal far from the input terminal of the scan signal, only the first storage capacitor can be disposed in each pixel, or the first storage capacitor and the second storage capacitor having the equivalent value can be disposed. For example, the appropriate position can be any position between ¼L to ½L.

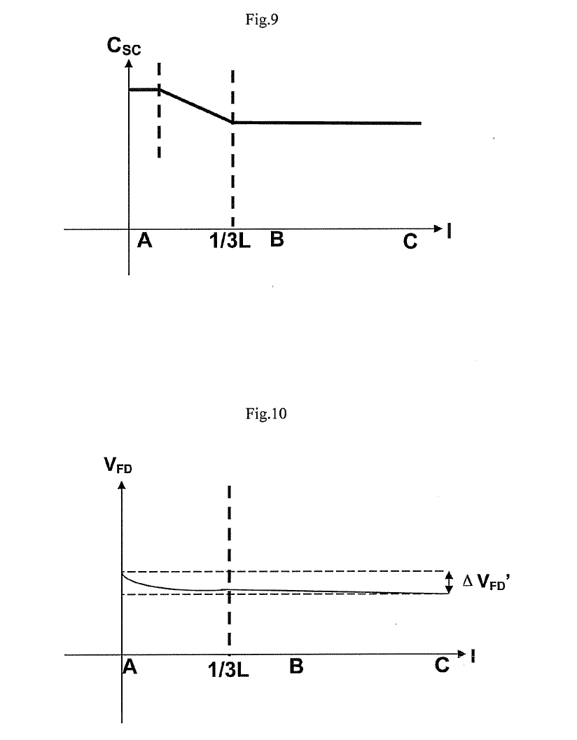

FIG. 9 illustrates a schematic view of a graph showing the change of the capacitance value of the pixel storage capacitor of a pixel as the distance between the pixel and the input terminal of a scan line according to the above embodiments of the invention changes. Referring to FIG. 9, the capacitance value of the pixel storage capacitor of pixel A (C_{SC})_{A}, which is closest to the input terminal of the scan signal, is largest, as it is at ⅓ L departing from the input terminal of the scan signal, the pixel storage capacitor in each pixel being decreased gradually. While from a place at ⅓ of the liquid crystal display panel length L departing from the input terminal of the scan signal to another terminal far from the input terminal of the scan signal, the capacitance value of the pixel storage capacitor in the respective pixels is kept to be unchangeable substantially

FIG. 10 illustrates a schematic view of a graph showing the change of the feed-through voltage V_{FD} as the distance l between the corresponding pixel and the input terminal of the scan line changes according to the above embodiments,of the invention. Comparing with the variation amount of the feed-through voltage V_{FD}, ΔV_{FD}, in the prior art as shown in FIG. 3, which is produced by the change of the distance l between the pixel and the input terminal of the scan line, after the capacitance value of the pixel storage capacitor in the pixel is adjusted by using the respective embodiments of the invention, the change amount of the feed-through voltage V_{FD}, ΔV_{FD}′, between the pixel which is the closest one to the input terminal of the scan signal and the pixel which Is the farthest one is smaller significantly than the change amount of the feed-through voltage V_{FD}, ΔV_{FD}, therebetween in the prior g that is, ΔD_{FD}′<<ΔV_{FD}.

In addition, it is easily understood by the skilled in the art that the liquid crystal display panel according to the above embodiments of the present invention may be manufactured to form a liquid crystal display device. And the liquid crystal display device has also the advantages of keeping the feed-through voltage of the respective pixels invariable and reducing the flicker phenomenon of the image of TFT-LCD effectively.

Specific embodiments of the invention have been described in the above description by referring to the drawings. However, it can be understood by those skilled in the art, various modifications and substitutions can be made to the specific embodiments of the invention without departing from the spirit and scope of the invention. These modifications and substitutions fall within the scope as defined in the Claims of the invention.

What is claimed is:

1. A liquid crystal display panel, comprising a plurality of scan lines, a plurality of data lines, a plurality of pixels formed by intersecting perpendicularly the scan lines with the corresponding data lines, and a plurality of pixel storage capacitors disposed in the pixels, wherein,
each of the pixel storage capacitors comprises a first storage capacitor and a second storage capacitor, and the capacitance value of each pixel storage capacitor is decreased as the distance between the corresponding pixel and the input terminal of the scan signal being increased.

2. The liquid crystal display panel as claimed in claim 1, wherein said first storage capacitor has a first capacitor electrode of said first storage capacitor, a second capacitor electrode of said first storage capacitor, and dielectric disposed between the first capacitor electrode of said first storage capacitor and the second capacitor electrode of said first storage capacitor.

3. The liquid crystal display panel as claimed in claim 1, wherein said second storage capacitor has a first capacitor electrode of said second storage capacitor, a second capacitor electrode of said second storage capacitor, and dielectric disposed between the first capacitor electrode of said second storage capacitor and the second capacitor electrode of said second storage capacitor.

4. The liquid crystal display panel as claimed in claim 3, wherein said first capacitor electrode of said second storage capacitor or said second capacitor electrode of the second storage capacitor further comprises an electron induced layer.

5. The liquid crystal display panel as claimed in claim 1, wherein the first capacitor electrode of said first storage capacitor and the fast capacitor electrode of said second storage capacitor are common.

6. The liquid crystal display panel as claimed in claim 1, wherein the capacitance value of said second storage capacitor is decreased as the distance between the corresponding pixel and the input terminal of the scan signal being increased.

7. The liquid crystal display panel as claimed in claim 6, wherein the capacitance value of said first storage capacitor is increased as the distance between the corresponding pixel and the input terminal of the scan signal being increased.

8. The liquid crystal display panel as claimed in claim 6, wherein as the distance between the corresponding pixel and the input terminal of the scan signal being increased, the decrease amount of the capacitance value of said second storage capacitor is larger than the increase amount of the capacitance value of the first storage capacitor.

9. The liquid crystal display panel as claimed in claim 1, wherein the value of said second storage capacitor is increased as the voltage value applied to the first capacitor electrode of said second storage capacitor being increased.

10. The liquid crystal display panel as claimed in claim 9, wherein the value of the voltage applied to a pixel close to the input terminal of the scan signal is larger than the value of the voltage applied to a pixel far from the input terminal of the scan signal.

11. The liquid crystal display panel as claimed in claim 9, wherein when different voltages are applied to the first capacitor electrodes of said second storage capacitors of the pixels, the pixels being different distances from the input terminal of the scan signal, the opposing areas between two electrodes of said second storage capacitors of different pixels are equal.

12. The liquid crystal display panel as claimed in claim 1, wherein said pixel storage capacitor can comprise only said first storage capacitor from a corresponding position departing from the input terminal of the scan signal to another terminal of said liquid crystal display panel far from the input terminal of the scan signal.

13. The liquid crystal display panel as claimed in claim 12, wherein said corresponding position is any position between ¼ length to ½ length of said liquid crystal display panel.

14. The liquid crystal display panel as claimed in claim 12, wherein said pixel storage capacitors in different pixels further comprise the second storage capacitor having the same capacitance value.

15. The liquid crystal display panel as claimed in claim 1, wherein if the length of said liquid crystal display panel is L, then from a position departing from the input terminal of the scan signal by ⅓L to another terminal of said liquid crystal display panel far from the input terminal of the scan signals, the capacitance values of pixel storage capacitors in each pixel are equal.

16. The liquid crystal display panel as claimed in claim 1, wherein said pixel storage capacitor is formed by connecting said first storage capacitor and said second storage capacitor in parallel.

17. A manufacturing method for the liquid crystal display panel, said method comprises the steps of:
forming the scan lines and the first capacitor electrodes;
forming a first insulating layer on said scan lines and said first capacitor electrodes;
depositing a semiconductor layer on said insulating layer to form an electron induced layer;
forming the data lines and the second capacitor electrodes; and
depositing sequentially a second insulating layer and a transparent conductive layer on said data lines and said second capacitor electrodes, and said transparent conductive layer forms the pixel electrodes and the third capacitor electrodes,
wherein the pixel storage capacitor in the pixel close to the input terminal of the scan signal is arranged to have a larger capacitance value than the pixel storage capacitor in the pixel far from the input terminal of the scan signal.

18. The manufacturing method as claimed in claim 17, wherein said pixel storage capacitor can comprise only said first storage capacitor from a corresponding position departing from the input terminal of the scan signal to another terminal of said liquid crystal display panel far from the input terminal of the scan signal.

19. The manufacturing method as claimed in claim 18, wherein said corresponding position is any position between ¼ length to ½ length of said liquid crystal display panel.

20. The manufacturing method as claimed in claim 18, wherein said pixel storage capacitor in different pixels her comprises the second storage capacitor having the same capacitance value.

21. The manufacturing method as claimed in claim 17, wherein said electron induced layer is made of amorphous silicon material, or polycrystalline semiconductor material, or monocrystalline semiconductor material.

22. A liquid display device at least comprising a liquid display panel, wherein the liquid display panel includes a plurality of scan lines, a plurality of data lines, a plurality of pixels formed by intersecting perpendicularly the scan lines with the corresponding data lines, and a plurality of pixel storage capacitors disposed in the pixels, characterized in that,
each of the pixel storage capacitors comprises a first storage capacitor and a second storage capacitor, and the capacitance value of each pixel storage capacitor is decreased as the distance between the corresponding pixel and the input terminal of the scan signal being increased.

23. The liquid display device as claimed in claim 22, wherein said first storage capacitor has a first capacitor electrode of said first storage capacitor, a second capacitor electrode of said first storage capacitor, and dielectric disposed between the first capacitor electrode of said first storage capacitor and the second capacitor electrode of said first storage capacitor, and said second storage capacitor has a first capacitor electrode of said second storage capacitor, a second capacitor electrode of said second storage capacitor, and dielectric disposed between the first capacitor electrode of said second storage capacitor and the second capacitor electrode of said second storage capacitor.

24. The liquid display device as claimed in claim 23, wherein said first capacitor electrode of said second storage capacitor or said second capacitor electrode of the second storage capacitor further comprises an electron induced layer.

25. The liquid display device as claimed in claim 22, wherein if the length of said liquid crystal display panel is L, then from a position departing from the input terminal of the scan signal by ⅓L to another terminal of said liquid crystal display panel far from the input terminal of the scan signal, the capacitance values of pixel storage capacitors in each pixel are equal.

26. The liquid display device as claimed in claim 22, wherein the capacitance value of said second storage capacitor is decreased as the distance between the corresponding pixel and the input terminal of the scan signal being increased.

27. The liquid display device as claimed in claim 26, wherein the capacitance value of said first storage capacitor is increased as the distance between the corresponding pixel and the input terminal of the scan signal being increased.

28. The liquid display device as claimed in claim 26, wherein as the distance between the corresponding pixel and the input terminal of the scan signal being increased, the decrease amount of the capacitance value of said second storage capacitor is larger than the increase amount of the capacitance value of the first storage capacitor.

29. The liquid display device as claimed in claim 22, wherein the value of said second storage capacitor is increased as the voltage value applied to the first capacitor electrode of said second storage capacitor being increased.

30. The liquid display device as claimed in claim 29, wherein the value of the voltage applied to a pixel close to the input terminal of the scan signal is larger than the value of the voltage applied to a pixel far from the input terminal of the scan signal.

31. The liquid display device as claimed in claim 22, wherein said pixel storage capacitor can comprise only said first storage capacitor from a corresponding position departing from the input terminal of the scan signal to another terminal of said liquid crystal display panel far from the input terminal of the scan signal.

32. The liquid display device as claimed in claim 22, wherein said pixel storage capacitor is formed by connecting said first storage capacitor and said second storage capacitor in parallel.
